(19) United States
(12) Patent Application Publication
(10) Pub. No.: US 2005/0171854 A1
(43) Pub. Date: Aug. 4, 2005

(54) Load sensing inventory tracking method and system

(76) Inventor: Geoff M. Lyon, Menlo Park, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/769,138

(22) Filed: Jan. 30, 2004

(51) Int. Cl. G06F 17/60

(52) U.S. Cl. 705/24

(57) ABSTRACT

A method and apparatus to ennumerate an aggregate of a stored product. An RFID tag attached to a product is interrogated to determine the product's identity which implies the product's unit weight. A gross weight of the stored product is determined by load sensors associated with the platform or container holding the product to be enumerated. A unit quanity of the stored product is determined from the product's unit weight and the gross weight of the stored product.

### BACKGROUND

The present invention relates to radio frequency identification (RFID) tags.

A tag serves to identify the thing to which it is attached. RFID tags can be attached to products to aid in their identification, speed checkout processing in a retail environment and aid in inventory management. The RFID tag is scanned or “interrogated” using radio frequency electromagnetic waves. Interrogating the RFID tag with radio waves allows the interrogator to be out of direct line-of-sight of the tagged item and to be located at a greater distance from the item than is generally permitted with optical scanning.

RFID tags can be either active or passive. Active RFID tags carry their own energy source and passive tags derive their energy from the interrogator's radio signal. When a passive RFID tag is in the vicinity of an interrogator, its antenna receives energy from a radio signal broadcast by the interrogator. This energy is rectified and used to power the RFID tag's integrated circuit. After the passive tag's integrated circuit is powered on, it will send its information to the interrogator. To reduce costs, inexpensive RFID tags generally do not have a conventional radio transmitter; instead, they communicate with a nearby interrogator using a communication technique known as “backscatter propagation.” Backscatter propagation involves modulating the antenna matching impedance of the RFID tag with the information to be sent to the interrogator. Modulating the impedance in this manner causes varying amounts of radio energy to be reflected from the tag's antenna, which are received and demodulated by the interrogator.

While techniques such as backscatter propagation allow the tag to be inexpensively constructed, the tag's signal is relatively weak. This weak signal is problematic when a number of tagged products are grouped together. The content of the tagged item or even the item's package may attenuate the tag's signal, making it difficult to receive by the interrogator. This in turn, can cause problems for inventory management systems if RFID tag signals are effectively blocked and some products cannot be identified.

Accordingly, there is a need for a system to precisely determine the number of tagged products in a locality using RFID.

### BRIEF DESCRIPTION OF THE DRAWINGS

The present invention is illustrated by way of example and not limitation in the figures of the accompanying drawings in which:

FIG. 1 is a perspective diagram illustrating a product storage unit incorporating RFID interrogator coils and load sensors in accordance with one implementation of the present invention;

FIG. 2A is a perspective diagram illustrating a weight-sensing shelf unit incorporating RFID interrogator coils and load sensors in accordance with one implementation of the present invention;

FIG. 2B is a perspective diagram illustrating a weight-sensing shelf unit with two independent weighing sections incorporating RFID interrogator coils and load sensors in accordance with one implementation of the present invention;

FIG. 2C is a perspective cutaway diagram illustrating a load sensor and its relationship to load sensor support and a shelf sensor plate in accordance with one implementation of the present invention;

FIG. 3 is a flowchart diagram of the operations pertaining to enumerating an aggregate of a stored product in accordance with one implementation of the present invention; and

FIG. 4 is a block diagram illustrating a system organization of the load-sensing inventory tracking system in accordance with one implementation of the present invention.

Like reference numbers and designations in the various drawings indicate like elements.

### SUMMARY OF THE INVENTION

One aspect of the present invention features a method for enumerating an aggregate of a stored product by the use of RFID tags working in conjunction with load sensors. The unit weight of the product is determined by identifying the product via an attached RFID tag. Load sensors supporting the platform or container holding the product determine the gross weight of the stored product. The unit quantity is determined from the gross weight and unit weight.

### DETAILED DESCRIPTION

Implementations of the present invention concern the use of load sensors working in conjunction with RFID interrogation to determine the number of tagged items stored in a particular locality. For example, a retail display might feature a shelf containing a number of containers of shampoo, each container identified by an attached RFID tag. Because shampoo and other products may attenuate or reflect radio energy, the RFID interrogation of some tags may be problematic, making the determination of the number of tagged items difficult. Implementations of the present invention solve this problem by both weighing the aggregate of the product and using RFID interrogation to accurately identify the product and its unit weight. The unit count is determined from the aggregate weight and the unit weight.

Aspects of the present invention are advantageous in at least one or more of the following ways.

Implementations of the present invention allow products that are identified with inexpensive RFID tags to be enumerated even though they may be clustered together, where either the products or their packages may attenuate some tag signals. For example, in a retail environment, accurate real-time knowledge of items on display allows for restocking of displays according to the rate at which items are removed from display. Inventory taking is also aided by an accurate enumeration of items within the retail environment.

A further advantage of the present invention is that inventory control systems do not have to be programmed to a particular product type being displayed on a specific display unit. So, for example, if the content of one shelf were exchanged with another shelf, the system would automatically adapt to the new stocking arrangement by sensing the products and their quantities in their new respective positions.

A further advantage of the present invention is that inventory control systems do not have to be programmed to a particular product type being displayed on a specific display unit. So, for example, if the content of one shelf were exchanged with another shelf, the system would automatically adapt to the new stocking arrangement by sensing the products and their quantities in their new respective positions.

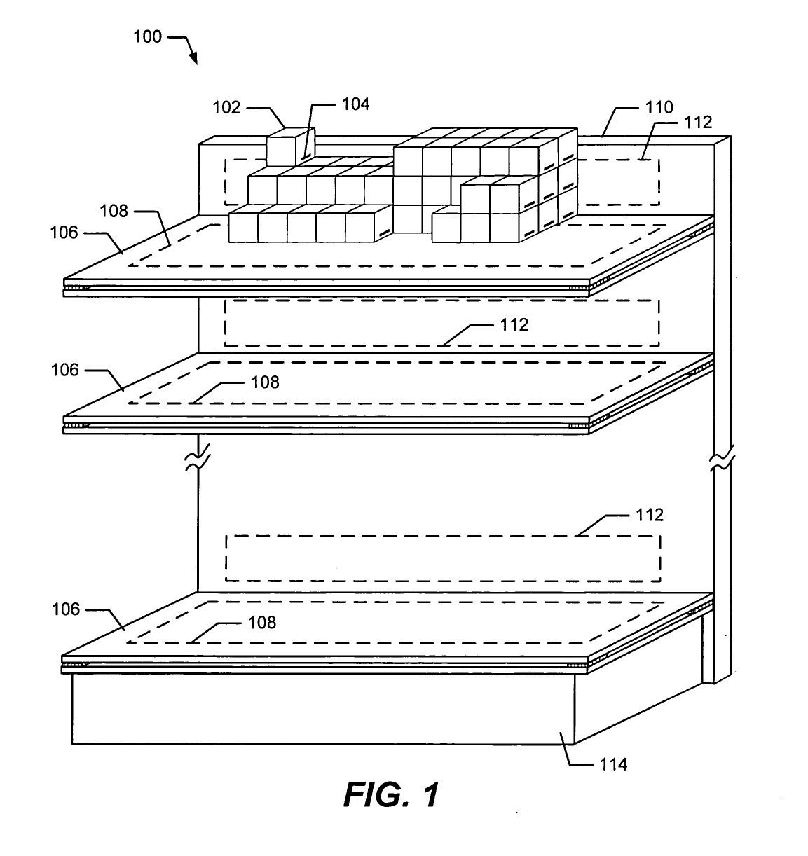

Turning first to FIG. 1, a perspective diagram illustrating a product storage unit 100 incorporating RFID interrogator coils and load sensors according to one implementation of the present invention. The unit is constructed from a shelf support 110 attached to and supported by a base 114. Within shelf support 110 is a set of one or more RFID vertical interrogator coils 112. Connected to shelf support 110 are one or more shelf units 106. Within shelf unit 106 is a horizontal RFID interrogator coil 108. Grouped upon shelf unit 106 are a group of similar items 102 identified with an RFID tag 104.

Shelf unit 106 serves to support and weigh the aggregate of item 102. RFID tag 104 of item 102 can be interrogated by horizontal interrogator coil 108, vertical interrogator coil 112, or a combination thereof. Horizontal interrogator coil 108 can either be on the surface or embedded at some depth in shelf unit 106. Similarly, vertical interrogator coil 112 can either be on the surface or embedded in 114 at yet another depth. Having two orthogonal interrogation fields provides better coverage of the shelf area and improves the read response of the system.

To allow flexibility in placing products, shelf unit 106 can be made detachable from shelf support 110 so that it can be arbitrarily attached to a number of positions on shelf support 110. Shelf support 110 is attached to base 114. Base 114 provides stability for the entire unit 100 and can also be used to house electronics associated with RFID interrogator coils 108 and 112 and the load sensors associated with shelf unit 106. In another implementation, shelf support 110 can be attached to a wall without the support of base 114.

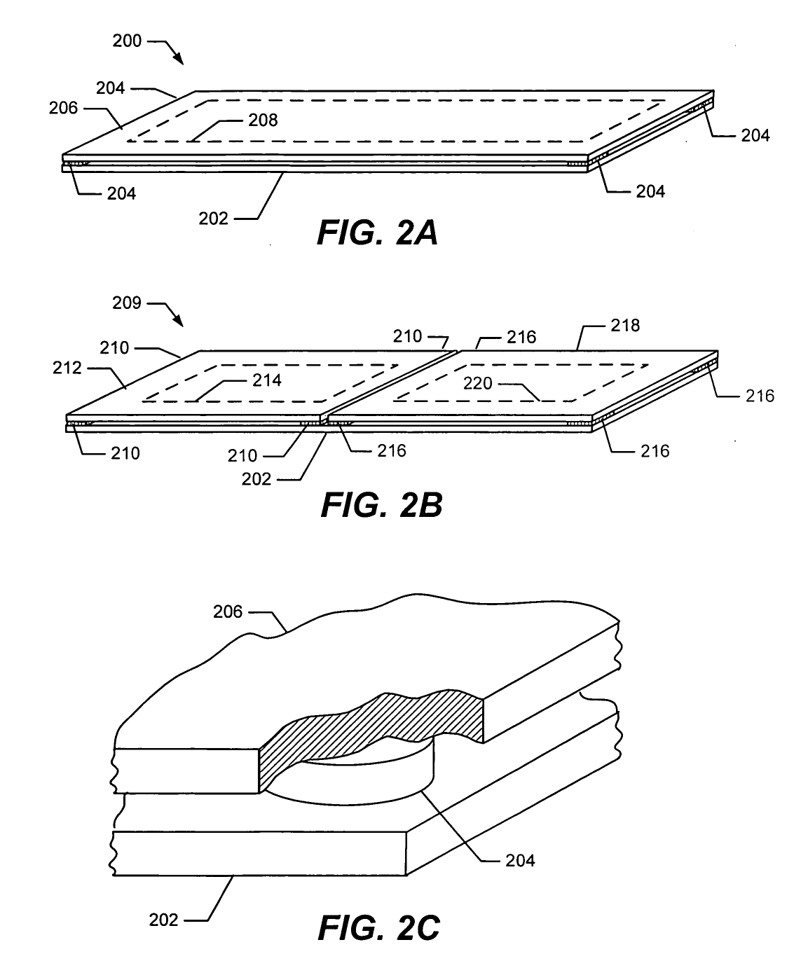

Turning now to FIG. 2A, a perspective diagram illustrating a weight sensing shelf unit 200 according to one implementation of the present invention. The unit is comprised of a load sensor support 202 that supports load sensors 204. Load sensors 204 support a shelf sensor plate 206. Associated with shelf sensor plate 206 is a horizontal RFID interrogator coil 208.

Shelf sensor plate 206 rests upon load sensors 204, which in turn are supported by load sensor support 202. An aggregate of product placed upon shelf sensor plate 206 exerts an additional force upon load sensors 204. This additional force causes load sensors to generate a voltage or current that is interpreted as the gross weight of the aggregate of the product. Horizontal RFID interrogator coil 208 can either be on the surface, embedded in, or beneath shelf sensor plate 206. If the coil is either embedded in or placed beneath shelf sensor plate 206, then the shelf sensor plate should be constructed of a material transparent to radio signals.

Multiple product types can be enumerated on a single shelf unit by dividing the shelf sensor plate into multiple independent sections. This is shown in FIG. 2B, a perspective diagram illustrating a weight-sensing shelf unit 209 with two independent weighing sections incorporating RFID interrogator coils and load sensors in accordance with one implementation of the present invention. Weight-sensing shelf unit 209 has both a left shelf sensor plate 212 and a right shelf sensor plate 218. Left shelf sensor plate 212 contains a horizontal RFID interrogator coil 214 and is supported by load sensors 210, which in turn are supported by load sensor support 202. Right shelf sensor plate 218 contains a horizontal RFID interrogator coil 220 and is supported by load sensors 216, which in turn are supported by load sensor support 202. Alternative implementations could include an arbitrary number of independent sections arranged variously left to right, front to back, or in any other symmetric or asymmetric, regular or irregular arrangement of areas.

An aggregate of one type of product placed on left shelf sensor plate 212 exerts an additional force on load sensors 210. This causes load sensors 210 to produce an output voltage that is interpreted as the gross weight of the aggregate of the product placed upon left sensor plate 212. Horizontal RFID interrogator coil 214 is used to read the identity of RFID tags attached to the product placed upon left shelf sensor plate 212.

Similarly, an aggregate of one type of product placed on right shelf sensor plate 218 exerts an additional force on load sensors 216. This causes load sensors 216 to produce an output voltage that is interpreted as the gross weight of the aggregate of the product placed upon right sensor plate 218. Horizontal RFID interrogator coil 220 is used to read the identity of RFID tags attached to the product placed upon right shelf sensor plate 212.

FIG. 2C is a perspective cutaway diagram illustrating a load sensor 204 and its relationship to a load sensor support 202 and a shelf sensor plate 206 in accordance with one implementation of the present invention. Load sensor 204 is sandwiched between shelf sensor plate 206 and load sensor support 202. Force applied to shelf sensor plate 206 is transferred to load sensor 204 that in turn produces an output voltage or current indicative of the gross weight upon shelf sensor plate 206.

Load sensor 204 can be implemented using either piezoelectric or strain gauge technologies. As the piezoelectric material in load sensor 204 is compressed, it will generate a charge that is conditioned by a charge amplifier to produce a voltage proportional to the compressional force.

Alternatively, load sensor 204 can be implemented using a strain gauge device that has strain-sensitive variable resistors bonded to an element that deforms as load is applied. In one implementation, the resistors of load sensor 204 are part of a Wheatstone bridge circuit that is powered by an excitation voltage applied across the bridge. With no force on the strain gauge, the voltage output from load sensor 204 can be adjusted to be zero. Then as force is applied to load sensor 204 and the strain gauge, the voltage output increases in proportion to the force applied. In either case, the output voltage can be converted to a digital value where it can then be used to determine the gross weight on shelf sensor plate 206.

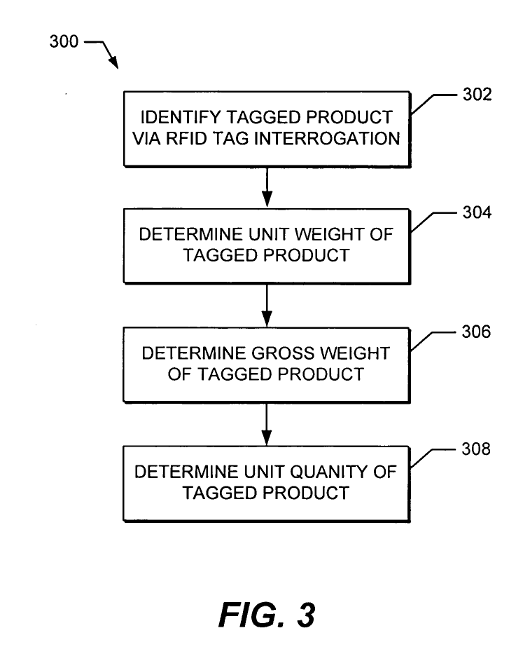

Turning now to FIG. 3, a flowchart diagram of the operations pertaining to enumerating an aggregate of a stored product 300 in accordance with one implementation of the present invention. To begin the process of enumeration of a product stored on a shelf, the identity of the tagged product is determined through RFID interrogation (302). RFID interrogation involves sending an interrogation signal through either the horizontal RFID interrogation coil in the shelf beneath the product, through the vertical interrogation coil in the shelf support behind the product, or a combination thereof The interrogation signal excites the product's passive RFID tag, causing it to convey a product identification signal back to the interrogation coil.

Once the product identification is known, it is possible to determine the unit weight of the product (304). In one implementation, the unit weight can be determined by using the product identification to index a database containing unit weights of various products. In another implementation, the unit weight of the product can be included as part of the product identification and can thus be obtained directly by RFID interrogation. For example, the product identification can include various data fields such as an identification number, a serial number, and a product unit weight.

To determine the gross weight of the tagged product (306), the aggregate of the product stored on the shelf is weighed by reading the output of the load sensors associated with the shelf. Since both the unit weight of the product and gross weight of the aggregate of the stored product are known, it is possible to determine the unit quantity of the tagged product (308). To obtain the unit quantity of the product, the gross weight of the aggregate is divided by the unit weight and the quotient is rounded to the nearest integer value. For example, if the unit weight of a product were indicated to be 100 grams and the measure gross weight were 3010 grams, then dividing 3010 by 100 yields a quotient of 30.10; rounding this quotient to the nearest integer yields a unit count of 30. The rounding operation is necessary because manufacturing tolerances may cause small variations in the unit weights of a product.

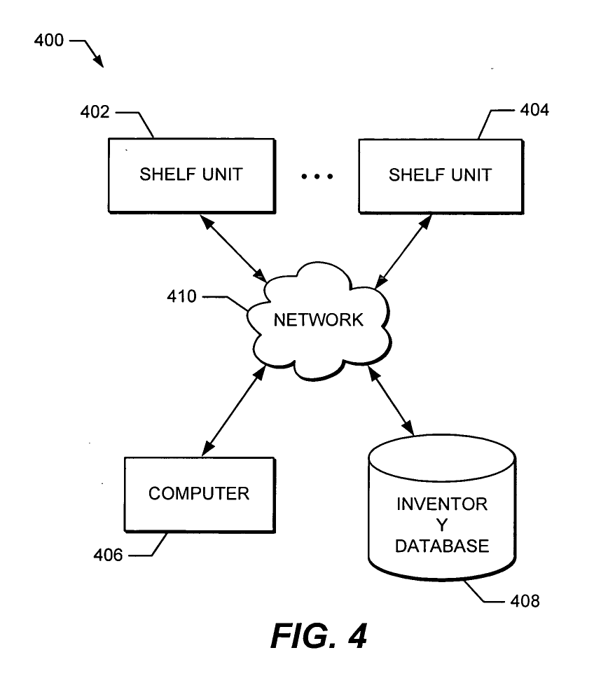

FIG. 4 is a block diagram 400 of a load-sensing inventory tracking system according to one implementation of the present invention. A load-sensing inventory tracking system 400 includes one or more load-sensing shelf units 402, 404, a computer 406, and an inventory database 408, all communicating over a network 410.

In one implementation, shelf unit 402 sends a product identification and a product gross weight to computer 406 over network 410 in response to a request from computer 406 received over network 410. Computer 406 indexes inventory database 408 with the product identification to obtain a product unit weight. The product unit weight is sent to computer 406 over network 410. Computer 406 calculates a unit quantity of the product stored on shelf unit 402 using the product gross weight and the product unit weight.

In another implementation, shelf unit 402 periodically indexes inventory database 408 with the product identification of the product stored upon it. Inventory database 408 responds by sending the unit weight of the product over network 410 to shelf unit 402. Shelf unit 402 calculates the unit quantity of the product from the gross weight and the unit weight. Computer 406 queries shelf unit 402 directly as to the product and the product unit quantity stored upon it.

In yet another implementation, shelf unit 402 indexes inventory database 408 with the product's identification when the product is first placed upon the shelf. Inventory database 408 responds by sending the unit weight of the product over network 410 to shelf unit 402. Shelf unit 402 calculates the unit quantity of the product from the gross weight and the unit weight. When the gross weight changes, the unit quantity is calculated and a message including the shelf unit identification, the product identification, and the product unit count is sent to computer 406 over network 410.

While examples and implementations have been described, they should not serve to limit any aspect of the present invention. Accordingly, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each compiuter program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

While specific embodiments have been described herein for the purposes of illustration, various modifications may be made without departing from the spirit and scope of the invention. Accordingly, the invention is not limited to the above-described implementations, but instead is defined by the appended claims in light of their full scope of equivalents.

1. A method for enumerating an aggregate of a stored product, comprising:
identifying the stored product;
receiving a unit weight of the identified product;
weighing of the aggregate of a stored product to determine a gross weight; and
calculating a unit quantity of the stored product based upon the unit weight and the stored weight.

2. The method of claim 1 wherein the identification of the stored product comprises interrogating an RFID tag attached to the product.

3. The method of claim 1 wherein the unit weight is determined from the product identification.

4. The method of claim 3 wherein the unit weight is included with the product identification.

5. The method of claim 3 wherein the unit weight is received from a database having weight information and indexed by the product identification.

6. The method of claim 1 wherein the weighing of the aggregate of the stored product occurs in a location where the product is stored.

7. The method of claim 6 wherein the location further comprises a platform, shelf, open bin, or lidded box.

8. The method of claim 6 wherein the weighing of the aggregate of the stored product further comprises sensing the weight with load sensors associated with the location where the product is stored.

9. The method of claim 1 wherein the unit quantity is proportional to the gross weight divided by the unit weight.

10. A shelf unit, comprising:
a load sensor support;
a set of one or more load sensors associated with the load sensor support;
a shelf sensor plate associated with the set of load sensors; and
an RFID interrogator coil in a location selected from the group of consisting of: on the surface of the shelf sensor plate, within the shelf sensor plate, and beneath the shelf sensor plate.

11. The shelf unit of claim 10 wherein the load sensor is placed upon the load sensor support.

12. The shelf unit of claim 10 wherein the shelf sensor plate is placed upon the load sensor.

13. The shelf unit of claim 10 wherein the shelf sensor plate is divided into two or more independent shelf sensor plates, each with its own set of load sensors.

14. The shelf unit of claim 10 wherein the load sensors are based upon either piezoelectric or strain-sensitive variable resistor technology.

15. The shelf unit of claim 10 wherein the RFID interrogator coil is a horizontal RFID interrogator coil.

16. An apparatus for enumerating an aggregate of a stored product, comprising:
a shelf support;
a set of one or more RFID interrogator coils contained within the shelf support;
a set of one or more weight-sensing shelf units-attached to the shelf support; and
a set of one or more horizontal RFID interrogator coils contained within the weight-sensing shelf unit.

17. The apparatus of claim 16 wherein the RFID interrogator coil contained within the shelf support is a vertical RFID interrogator coil.

18. The apparatus of claim 16 wherein the RFID interrogator coil contained within the weight-sensing shelf unit is a horizontal RFID interrogator coil.

19. The apparatus of claim 16 further comprising a base attached to the shelf support.

20. The apparatus of claim 16 wherein the weight-sensing shelf units are attachable at various positions on the shelf support.

21. The apparatus of claim 16 wherein the weight-sensing shelf unit comprises:
a load sensor support;
a set of one or more load sensors associated with the load sensor support;
a shelf sensor plate associated with the set of load sensors; and
an RFID interrogator coil in a location selected from the group of consisting of: on the surface of the shelf sensor plate, within the shelf sensor plate, and beneath the shelf sensor plate.

22. The weight-sensing shelf unit of claim 21 wherein the load sensor is placed upon the load sensor support.

23. The weight-sensing shelf unit of claim 21 wherein the load sensor plate is placed upon the load sensor.

24. The weight-sensing shelf unit of claim 21 wherein the shelf sensor plate is divided into two or more independent shelf sensor plates, each with its own set of load sensors.

25. The weight-sensing shelf unit of claim 21 wherein the load sensors are based upon either piezoelectric or strain-sensitive variable resistor technology.

26. The weight-sensing shelf unit of claim 21 wherein the RFID interrogator coil is a horizontal RFID interrogator coil.

27. A system for enumerating an aggregate of a stored product, comprising:
one or more load-sensing shelf units capable of weighing one or more product aggregates, determining a product identification using RFID, and communicating over a network;
a computer capable of communicating over the network; and
an inventory database indexable by product identification, including a unit weight of the product, and capable of communicating over the network.

28. The system of claim 27 wherein the computer queries the load-sensing shelf unit as to the identity and gross weight of the product stored upon it.

29. The system of claim 28 wherein computer queries the load-sensing shelf periodically.

30. The system of claim 27 wherein the computer queries the load-sensing shelf unit as to the identity and unit quantity of the product stored upon it.

31. The system of claim 30 wherein computer queries the load-sensing shelf periodically.

32. The system of claim 27 wherein the computer receives a message from the load-sensing shelf unit as to a shelf identity and the identity and unit quantity of the product stored upon it.

33. The system of claim 32 wherein computer receives a message from the load-sensing shelf when the unit quantity of the product stored upon it changes.

34. The system of claim 27 wherein the network comprises the Internet.

35. The system of claim 27 wherein the product unit weight is included with the product identification.

36. An apparatus for enumerating an aggregate of a stored product, comprising:
means for identifying the stored product;
means for receiving a unit weight of the identified product;
means for weighing of the aggregate of a stored product to determine a gross weight; and
means for calculating a unit quantity of the stored product based upon the unit weight and the stored weight.

37. A computer program product for enumerating an aggregate of a stored product, tangibly stored on a computer-readable medium, comprising instructions that operate to:
identify the stored product;
receive a unit weight of the identified product;
weigh of the aggregate of a stored product to determine a gross weight; and
calculate a unit quantity of the stored product based upon the unit weight and the stored weight.

38. The computer program of claim 37 wherein the identification of the stored product comprises interrogating an RFID tag attached to the product.

39. The computer program of claim 37 wherein the unit weight is determined from the product identification.

40. The computer program of claim 39 wherein the unit weight is included with the product identification.

41. The computer program of claim 39 wherein the unit weight is received from a database having weight information and indexed by the product identification.

42. The computer program of claim 37 wherein the weighing of the aggregate of the stored product occurs in a location where the product is stored.

43. The computer program of claim 42 wherein the weighing of the aggregate of the stored product further comprises sensing the weight with load sensors associated with the location where the product is stored.

44. The computer program of claim 37 wherein the unit quantity is proportional to the gross weight divided by the unit weight.
